(19) United States
(12) Patent Application Publication
(10) Pub. No.: US 2004/0085318 A1
(43) Pub. Date: May 6, 2004

(54) Graphics generation and integration

(76) Inventors: Philipp Hassler, Leimen (DE); Michael Lutz, Leimen (DE); Markus Pins, Karlsruhe (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/285,283

(22) Filed: Oct. 31, 2002

(51) Int. Cl. G06T 11/20

(52) U.S. Cl. 345/440

(57) ABSTRACT

A method, performed by a server, generates graphics to output to an external application. The method includes receiving instructions originating from the external application, generating one of plural different types of graphics based on the instructions by combining elements from one or more graphics sources, and outputting the graphics to the external application.

### TECHNICAL FIELD

This application relates generally to obtaining graphic information from a remote device, such as a server.

### BACKGROUND

Graphics have become an integral part of many types of computer applications. For example, graphics, such as pie charts and bar charts, may be generated by a computer to compare sets of information. The generation and integration of various graphics elements has become a popular area of focus among software developers in recent years.

### SUMMARY

In general, in one aspect, the invention is directed to a method, performed by a server, that generates graphics to output to an external application. The method includes receiving instructions originating from the external application, generating one of plural different types of graphics based on the instructions by combining elements from one or more graphics sources, and outputting the graphics to the external application. By providing a graphics service to an external application, and one that combines elements from one or more graphics sources, this aspect of the invention provides the external application with a wide variety of graphics options without consuming resources that would otherwise be dedicated to running the application.

This aspect of the invention may include one or more of the following features. The method may include interpreting the instructions such that the graphics are generated based on the interpreted instructions. The instructions may include XML code and interpreting may include parsing the XML code.

Generating the graphics may include obtaining geographic information from a geocoding service and integrating the geographic information into the graphics. The geographic information may include a map and integrating may include combining the map with other graphics.

Generating the graphics may include retrieving the elements for the graphics and arranging the elements to create the graphics. The elements may be retrieved from one or both of a database that is internal to the server and a database that is external to the server. The graphics may include one or more of network graphics and charts. Generating the graphics may include converting the graphics from one format into a different format and/or converting the graphics from one size into a different size.

Other features and advantages of the invention will become apparent from the following description, including the claims and drawings.

### DESCRIPTION OF THE DRAWINGS

FIG. 1 is a block diagram of a network containing an Internet Graphics Server.

FIG. 2 is a block diagram of the software architecture of the Internet Graphics Server.

FIG. 3 is a flowchart showing a process for providing data to the Internet Graphics Server.

FIG. 4 is a flowchart showing a process performed by the Internet Graphics Server for providing a generic interface to plural geo-servers.

FIGS. 5, 6, and 7 show graphics output provided by the Internet Graphics Server.

FIG. 8 is a flowchart showing a process performed by the Internet Graphics Server for providing graphics output.

### DESCRIPTION

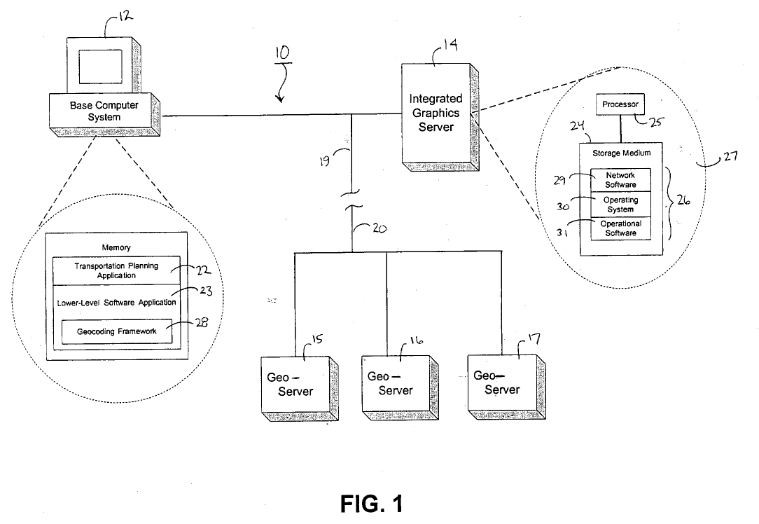

Referring to FIG. 1, a network 10 includes a base computer system 12, an Internet Graphics Server (IGS) 14, and multiple geo-servers 15, 16, 17. Connections between these and other devices on network 10 may be via Ethernet, phone line, and/or wireless link, for example. Network 10 may include a local portion 19 comprised of base computer system 12 and IGS 14 and an external portion 20 comprised of geo-servers 15, 16, 17. The local portion may be a local area network (LAN) running a protocol such as RFC, and the external portion may be a wide area network (WAN) and/or the Internet running a protocol such as HTTP (HyperText Transfer Protocol). It is noted that devices depicted on the local portion may be on the external portion and vice versa.

Geo-servers 15, 16, 17 are used by various geocoding services, such as the ESRI ArcIMS and PTV eMapServer, to provide output geographic information to IGS 14 in response to input geographic information received from IGS 14. Generally speaking, the term “geocoding” refers to converting input geographic information, such as addresses, into output geographic coordinates. Geo-servers services, however, also provide other features, such as route planning and distance calculation. These features enable users to plan routes and determine distances between specified locations. Geo-servers also provide road maps, as described below.

Thus, the input or output geographic information referred to above may include geographic coordinates (e.g., a longitude and latitude) of an address. The input or output geographic information may include a street address, a city, a country, and the like. The output geographic information may also include, e.g., routes, such as streets, between two locations, travel time between those locations, and map(s) showing the locations, and the like. Geographic information other than that described here may also be used for input or output.

IGS 14 has a server architecture in which data from base computer system 12 and/or other source(s) can be used to generate graphical or non-graphical output. IGS 14 can be used to encapsulate geo-servers' functionality. To this end, IGS 14 provides, to the base computer system or other source(s), geographic services including, but not limited to, sending and receiving requests for displaying maps, routes, planning, coordinates, and addresses.

Base computer system 12 runs one or more software applications, which may provide inputs to IGS 14. Among these applications is transportation planning application 22. Transportation planning application 22 contains various features relating to supply chain management. Supply chain management refers, generally, to managing commerce (e.g., product shipments) between a manufacturer, various intermediaries, such as distribution centers, wholesalers and the like, and customers. Transportation planning application 22 may be used to determine routes for transporting goods along the supply chain, among other things. Transportation planning application 22 generates one or more graphical user interfaces (not shown) that include one or more fields for entering geographic (and other) information that can be provided to IGS 14.

In this embodiment, IGS 14 is a dedicated computer or other processing device that contains memory 24 and one or more processors 25 that run software (executable instructions) 26 stored in memory 24 to provide the functionality described herein (see view 27, which depicts the architecture of IGS 14). It should be noted, however, that the IGS is not limited to this architecture and, instead, can include any combination of hardware and/or software, as noted below.

Software 26 may include, but is not limited to, network software 29 for communicating over network 10, operating system software 30, and operational software 31 for transmitting information between geo-servers 15, 16, 17 and base computer system 12. Operational software 31 may include various modules that convert data between formats for transmission to applications running on base computer system 12 and from such applications to a geo-server.

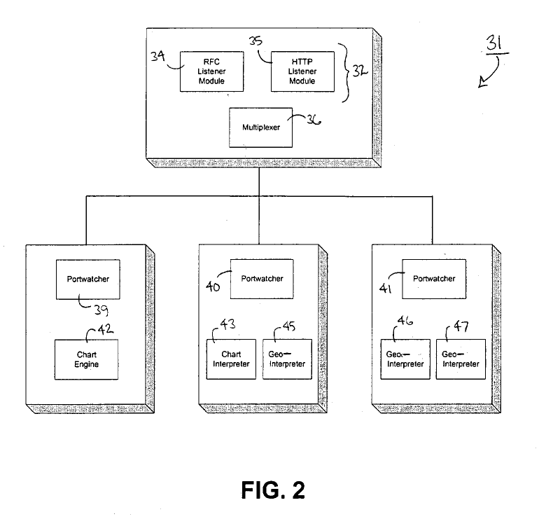

FIG. 2 shows the architecture of operational software 31 in one embodiment of IGS 14. Operational software 31 includes communication modules 32. Communication modules 32 include RFC listener module 34 and HTTP listener module 35. RFC listener module 34 and HTTP listener module 35 “listen” for communications from network 10, e.g., to pick-up communications from base computer system 12.

More specifically, communication modules 32 receive data from network 10, filter the data to detect IGS-destined communications, convert the data from the RFC or HTTP format to an IGS-internal data format, and provide the resulting converted data to multiplexer 36. Communication modules 32 also output data from IGS 14 (to, e.g., base computer system 12) onto network 10, in the process performing any necessary conversions to RFC or HTTP format.

Multiplexer 36 is the central instance for data communications between communication modules 32 and portwatchers 39, 40, 41 (described below). Multiplexer 36 sends data packets from a communication module, via a portwatcher, to an interpreter (described below). Multiplexer 36 “knows” which interpreters are available and therefore can assign the data packets based on the number of available interpreters in order to balance the load of each interpreter.

Multiplexer 36 can also turn interpreters on and off via a portwatcher. As a result, multiplexer 36 can perform active load balancing. That is, if the number of data packets exceeds a predetermined limit, then multiplexer 36 can turn on an interpreter and thereby lessen the number of data packets that each of the other interpreters must process. In this embodiment, there is one multiplexer for IGS 14; however, any number of multiplexers can be used.

A portwatcher is a software module that instantiates the components (e.g., the interpreters) configured for the portwatcher, registers with multiplexer 36, and informs multiplexer 36 of the interpreters that are available.

Each portwatcher communicates with multiplexer 36 using a socket interface or a shared memory if the multiplexer and portwatchers use the same hardware. A portwatcher receives its “requests” (e.g., to generate an image or to obtain geocoordinates) from multiplexer 36 and can return its status if requested by multiplexer 36. Requests that portwatchers receive from multiplexer 36 are sent by the portwatchers to the appropriate interpreters. A portwatcher may service one or more software modules (e.g., interpreters, engines, etc.). These software modules carry-out the requests and send results back to multiplexer 36 via the portwatchers.

Software modules 42, 43, 45, 46, 47, which are C++ “plug-ins” in this embodiment, are installed on IGS 14. Different software modules perform different functions. IGS Geo-services Referring to FIGS. 1 and 2, geo-interpreters 45, 46, 47 correspond to respective geo-servers 15, 16, 17. Each geo-interpreter is designed to communicate with its corresponding geo-server. A single geo-interpreter may communicate with multiple geo-servers and multiple geo-interpreters may communicate with a single geo-server.

Each geo-server 15, 16, 17 is capable of recognizing data having a specific format. Data that is not formatted properly, in general, cannot be processed by the geo-server and/or may not be processed properly. Geo-interpreters 45, 46, 47 perform data formatting for their respective geo-servers 15, 16, 17. For example, in a case that geo-interpreter 45 is written for geo-server 15, geo-interpreter 45 generates data that is in a communication format that geo-server 15 understands. In a case that geo-interpreter 46 is written for geo-server 16, geo-interpreter 46 generates data that is in a format that geo-server 16 understands, and so on.

Each geo-server also has a specific access protocol. The geo-interpreters are therefore also configured to provide the correct access protocol for their corresponding geo-servers.

Any number of geo-interpreters may be installed per IGS, thereby permitting connection to any number of different geo-servers. Interpreters may also be included in IGS 14 to connect to other geographic and/or non-geographic information systems, such as map databases and the like.

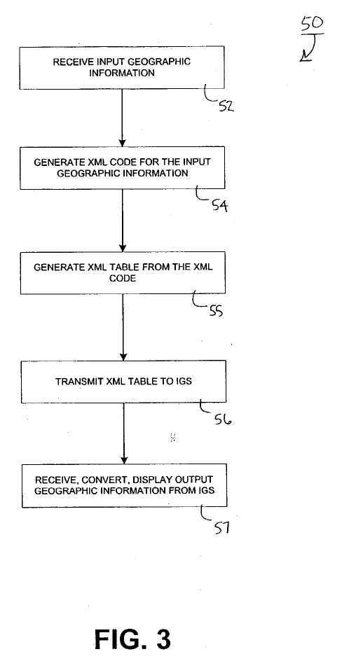

FIG. 3 shows a process 50 to provide geocoding services from IGS 14 to transportation planning application 22. Transportation planning application 22 receives (52) input geographic information from one or more GUIs (not shown). Transportation planning application 22 passes the input geographic information to a lower-level software application 23 on base computer system 12. Lower-level software application 23 generates (54) standard extensible Markup Language (XML) code that defines the address information and passes that XML code to a geographic framework application 28 within lower-level application 23.

Geographic framework application 28 generates (55) a table from the XML code and passes that table back to transportation planning application 22. Geographic framework application 28 generates the table by extracting XML fields from the XML code and inserting the former XML fields into the table. In this embodiment, the table is a look-up table (LUT) containing rows that include the XML code; however, other types of tabular and non-tabular formats may be used. Transportation planning application 22 transmits (56) the table containing the XML code to IGS 14 via network 10 using a protocol such as HTTP or RFC.

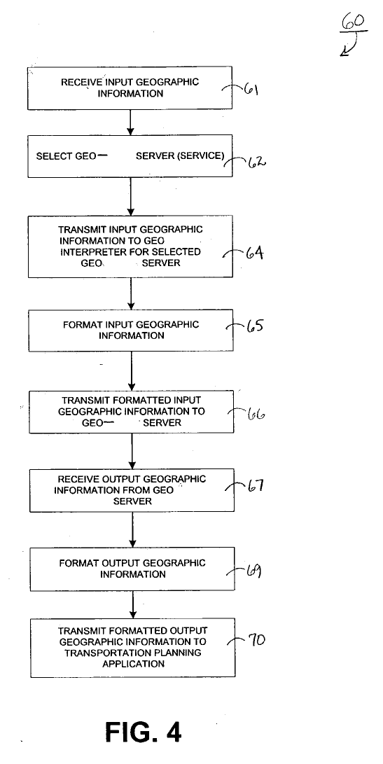

FIG. 4 shows a process 60, which is performed by software in IGS 14 for obtaining geographic information from one (or more) of geo-servers 15, 16, 17. Process 60 receives (61) input geographic information from transportation planning application 22. As noted above, the input geographic information is formatted as a table containing XML code.

Process 60 selects (62) a geo-server from which to obtain output geographic information that corresponds to the input geographic information. Process 60 may select the geo-server based on one or more factors. For example, the input geographic information may include an indication of which geo-server to select. A user running transportation planning application 22 may input the indication of which geo-server to select or IGS 14 or transportation planning application 22 may select a geo-server automatically based on the input geographic information (or some other criteria). Alternatively, multiplexer 36 (FIG. 2) may select the geo-server, e.g., to perform load balancing, as described above.

By way of example, one geo-server 15 may provide more accurate information for a particular country, such as Germany, than another geo-server 16. Accordingly, IGS 14 may contain a rule whereby each time a user indicates an address in Germany, IGS 14 automatically selects geo-server 15. The same process may be applied for other fields as well. For example, one geo-server may provide more accurate information for a particular continent (e.g., Europe), area of a city, country, or for a particular mode of transportation. For example, one geo-server may provide more accurate information for roadways and another geo-server may provide more accurate information for railways.

In other instances, the desired geographic information may not be available from one geo-server, but may be available from another geo-server. If IGS 14 knows beforehand which geo-servers provide which information, IGS 14 can direct requests accordingly. If IGS 14 does not know the types of information available from the various geo-servers, IGS 14 can request the information from more than one geo-server. For example, IGS 14 can output a request to multiple geo-servers concurrently, or try each geo-server sequentially until IGS 14 obtains the requested information.

Process 60 transmits (64) the input geographic information to an interpreter that corresponds to the selected geo-server. For example, if ESRI is selected as the geo-server, process 60 transmits the input geographic information to the interpreter that is designed to work with ESRI. As noted above, this transmission may be performed via multiplexer 36 and a portwatcher.

The interpreter receives the input geographic information and formats (65) the input geographic information (i.e., the generic XML-tabular format described above) so that it is compatible with the selected geo-server. That is, the interpreter converts the data so that the format of the input geographic information is compatible with the data format of the selected geo-server. In the example described above, if the ESRI interpreter is selected, the interpreter converts the generic XML tabular data to the data format that is recognized by ESRI. The same process is true for interpreters for other geocoding services. Thus, IGS 14 provides a generic interface to multiple geo-servers.

Process 60 transmits (66) the reformatted input geographic information from the interpreter to the selected geocoding service, together with any instructions, such as the type of data requested from the geocoding service. Transmission may be over a network, such as the Internet or the like. Since the data is in the format that is recognized by the geo-server, the geo-server can process the data and provide the requested output geographic information. For example, if the input geographic information is geographic coordinates, the output geographic information provided by the geo-server may be specific addresses that correspond to the input geographic coordinates.

The geo-server transmits its output (the output geographic information) back to IGS 14. The appropriate communication module, e.g., RFC listener module 34 or HTTP listener module 35, receives (67) the transmission and, via multiplexer 36 and a portwatcher, provides the output geographic information to the appropriate interpreter. For example, if ESRI provides the output geographic information, the output geographic information is provided to the geo-interpreter (e.g., geo-interpreter 17) that is used to communicate with the ESRI server.

Geo-interpreter 17 formats (69) the output geographic information so that a format of the output geographic information is compatible with a device that provided the input geographic information. In this embodiment, the interpreter converts the geographic information received from the geo-server from the format that is recognizable by the geo-server to the XML-tabular format described above. Other conversions, however, may be performed.

Interpreter 17 transmits (70) the output geographic information in XML-tabular format back to transportation planning application 22. Transmission may be via a network, such as the Internet. Referring to FIG. 3, transportation planning application 22 receives (57) the output geographic information from interpreter 17, performs any necessary conversions on the output geographic information, and displays the results in a GUI (not shown).

Different types of geocoding functions may be available through IGS 14 depending on the capabilities of the various geo-servers. These functions may be provided by sending the necessary instructions to a geo-server, obtaining the information from the geo-server, and sending that information back to the transportation planning application in the manner described above. In some cases, which are specified below, IGS 14 may perform some additional processing on data received from a geo-server before sending the data back to the transportation planning application.

The IGS “routing” function determines the route, distance and drive time between a start location and an end (target) location. IGS 14 provides the start and end locations (e.g., addresses, geographic coordinates, etc.) to a geo-server, which replies with the route, distance and drive time between the start and end locations. In addition, a user may define a sequence of stop-over locations (i.e., scheduled stops) that have to be passed on the way from the start location to the end location. The effects of these stop-over locations on the overall route, distance and drive time are taken into account by the geocoding service when determining the route, distance and drive time. The start and end locations may be defined in terms of their geographic coordinates, as described above.

The “average speed” function determines the expected average speed along a specified route. This information is provided by a geo-server once a route between two locations is specified, and can take into account the type of roadway along the route. For example, the average speed function may take into account whether a roadway is a highway, freeway, city road, etc. The geo-server uses the expected average speed, along with the route's distance, to determine the expected travel time along the route.

The “route determination” function is performed in IGS 14. The route determination function receives, from one or more geo-servers, several routes between a start location and an end location and selects one of the routes based on input criteria. For example, the criteria may be to select the shortest route or the quickest route. Other information, such as that described above with respect to the average speed function, may be used in making the selection. The information is then provided from IGS 14 to the transportation planning application, as noted above.

The “distance and duration matrix” function is performed by IGS 14. This function determines a matrix of distances and durations between various locations based on distances and durations obtained from one or more geo-servers.

The “map display” function generates a map for a given area defined by two geocoordinates. The two geocoordinates, which define opposite (diagonal) corners of the map, are provided to a geo-server. The geo-server replies with the requested map. The map can have different levels of detail. The level of detail depends on the geocoding service(s) used to obtain information for the map.

Several additional functions may be provided through IGS 14 that can affect the way a map is displayed. These functions may be implemented through a geo-server. The functions include displaying descriptive text, such as names or other information, on the map, displaying objects on the map in different styles, displaying different routes between two points in different colors, and displaying different types of objects in different shapes and colors. Other functions include the ability to zoom-in or zoom-out on a map, and to resize a container (e.g., window) that displays the map.

A map can be provided in different graphic formats, such as bitmap, JPEG, GIF, PNG, etc. The map can be displayed with different layers, e.g., rivers, roads, etc. A legend can be displayed on the map showing information such as the scale of the map and the like. Different regions of the map can be colored differently, e.g., to highlight different area code regions (see below). Customers can be moved on the map and, in this way, assigned a different route. A path can be generated by drawing a line from one customer to another customer and then performing the necessary calculations to determine the driving route between the two customers.

IGS Graphics Services

Software modules may also be included on IGS 14 to provide graphics services. These graphics modules are computer programs, which may be written in C++, that perform the functions described herein. The graphics services may be used independently of, or in conjunction with, the foregoing IGS geographic services. The IGS graphics services may be implemented using chart engine 42 (FIG. 2), using chart interpreter 43, or using a combination of the two. Chart interpreter 43 may be used to obtain graphics data from external graphics servers. The process that chart interpreter 43 uses to communicate with external servers to obtain graphics is identical to process 60 of FIG. 4, except that graphics, not geographic information, is obtained.

The graphics modules (e.g., chart engine 42 or chart interpreter 43) receive an instruction set, which may be XML (or other programming language) code, read the instructions for an indication of the type of graphics to be generated, retrieve any necessary graphic elements from an internal graphics library (not shown) or external graphics (or geocoding) service, generate the requested graphics from the graphics elements, and provide the generated graphics back to the requestor. Examples of graphics modules are set forth below. It is noted that other graphics modules may be used with IGS 14 in addition to, or instead of, the graphics modules described herein.

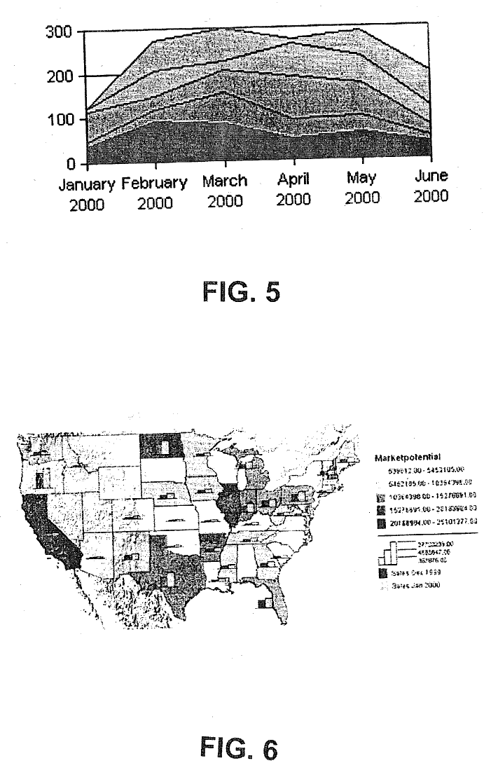

The Tensegrity chart module generates business graphics output via RFC by following instructions provided in ABAP programming language code. A business graphics produced by the Tensegrity chart interpreter is shown in FIG. 5.

The BWGIS module generates business maps out of BW data and ESRI files (geocoding service data). The BWGIS interpreter is used in the context of BW Bex WebReporting to render maps, such the map shown in FIG. 6.

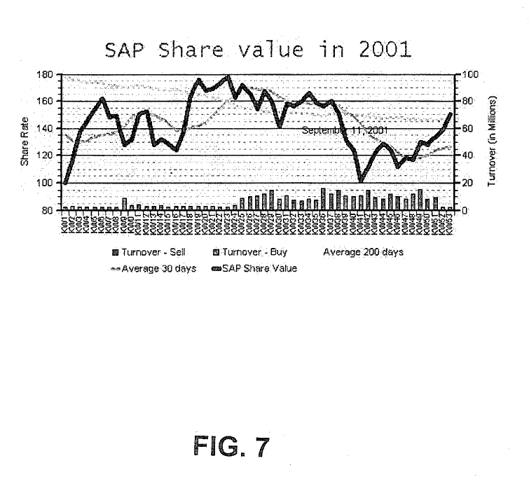

The XML chart module generates business graphics output by parsing data provided in input XML code and displaying that data in graphics, such as a column or chart. The XML chart module is an XML-based, platform-independent application that is compatible with Unicode. An example of graphics output generated by the XML chart module is shown in FIG. 7. The XML charter module can generate category charts, portfolio charts, and scatter charts, among other types of charts.

The Image Converter module converts images between different file formats, such as TIFF to GIF, and may be used to resize images, if so instructed. In this regard, the Image Converter module may also be used to separate multi-page facsimile images into separate GIFs and/or to generate “thumbnail” images of one or more larger input images.

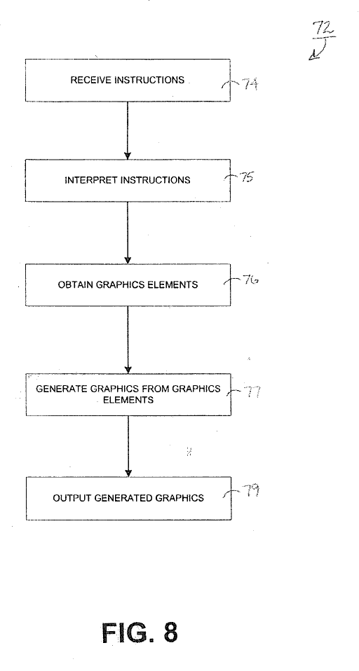

FIG. 8 shows a process 72, which may be implemented in chart engine 42, chart interpreter 43, and/or a geo-interpreter, to provide IGS graphics services. Process 72 receives (74) instructions from an external source, such as transportation planning application 22 or any other computer program. As noted above, the instructions are received via a communications module, multiplexer, and portwatcher.

Process 72 interprets (75) the instructions that it received from the external source. Interpreting the instructions may include parsing the instructions from an XML (or other formatting language) document and/or executing a computer program (e.g., an applet) which contains the instructions. One or more of the graphics interpreters described above may be used to interpret the instruction and generate the graphics based on the instructions.

The instructions provide an indication of the type of graphics to be generated. For example, the instructions may be to convert designated images (which may be transmitted with the instructions) into “thumbnail” format and provide the resulting thumbnail images back to the source device. In another example, the instructions may be to generate a chart comprised of a map obtained from a geocoding service and associated data provided along with the instructions.

Process 72 obtains (76) the graphics elements that are needed to generate the graphics specified in the instructions. Process 72 may obtain these elements from a pre-existing database that is stored on IGS 14 or that is otherwise accessible to IGS 14 via a network or the like. Process 72 may obtain some graphics, such as maps, via a geo-server that is accessible to IGS in the manner described above. For example, instructions may indicate to generate a map and to shade portions of the map. In this case, the map may be obtained via a geo-server. Chart engine 42 and/or chart interpreter 43 may then provide any shading and add any other required elements.

Thus, as described above, process 72 arranges the graphics elements in the manner specified by the instructions to generate (77) the desired graphics. Process 72 outputs (79) the generated graphics to the external source (e.g., transportation planning application 22), where the graphics may be displayed to a user.

Other Embodiments

FIG. 1 shows a computer (i.e., a server) on which processes 60 and 72 may be implemented. Although a computer is shown in FIG. 1, processes 60 and 72 are not limited to use with the hardware and software of FIG. 1. They may find applicability in any computing or processing environment. Processes 60 and 72 may be implemented in hardware, software, or a combination of the two.

Processes 60 and 72 may be implemented in computer programs executing on one or more programmable computers or other machines that each include a processor and a storage medium readable by the processor (including volatile and nonvolatile memory and/or storage components).

Each such program may be implemented in a high-level procedural or object-oriented programming language to communicate with a computer system. However, the programs can be implemented in assembly or machine language. The language may be a compiled or an interpreted language.

Each computer program may be stored on a storage medium or other article of manufacture (e.g., CD-ROM, hard disk, or magnetic diskette) that is readable by a general or special purpose programmable computer for configuring and operating the computer when the storage medium or device is read by the computer to perform processes 60 and 72. Processes 60 and 72 may also be implemented as a machine-readable storage medium, configured with computer program(s), where, upon execution, instructions in the computer program(s) cause a machine to operate in accordance with processes 60 and 72.

The inventions are not limited to the embodiments described above. For example, IGS 14 is not limited to use with the geocoding services mentioned herein. Any geocoding service may be used with IGS 14. In fact, IGS 14 is not limited to use with geocoding services. Plug-ins may be designed and installed on IGS 14 to effect communication between IGS 14 and any third-party service or database that can provide information and that has a specific communication format. IGS 14 is not limited to generating the graphics described herein. Any type of graphics may be generated using internal IGS tools or external tools.

Other embodiments not described herein are also within the scope of the following claims.

What is claimed is:

1. A method, performed by a server, to generate graphics to output to an external application, comprising:
receiving instructions originating from the external application;
generating one of plural different types of graphics based on the instructions by combining elements from one or more graphics sources; and
outputting the graphics to the external application.

2. The method of claim 1, further comprising:
interpreting the instructions, the graphics being generated based on the interpreted instructions.

3. The method of claim 2, wherein the instructions comprise XML code and interpreting comprises parsing the XML code.

4. The method of claim 1, wherein generating the graphics comprises:
obtaining geographic information from a geocoding service; and
integrating the geographic information into the graphics.

5. The method of claim 4, wherein the geographic information comprises a map and integrating comprises combining the map with other graphics.

6. The method of claim 1, wherein generating the graphics comprises:
retrieving the elements for the graphics; and
arranging the elements to create the graphics.

7. The method of claim 1, wherein the elements are retrieved from one or both of a database that is internal to the server and a database that is external to the server.

8. The method of claim 1, wherein the graphics comprise one or more of network graphics and charts.

9. The method of claim 1, wherein generating the graphics comprises converting the graphics from one format into a different format.

10. The method of claim 1, wherein generating the graphics comprises converting the graphics from one size into a different size.

11. A machine-readable medium containing computer-executable code, which is executed by a server, to generate graphics to output to an external application, the computer-executable code causing the server to:
receive instructions originating from the external application;
generate one of plural different types of graphics based on the instructions by combining elements from one or more graphics sources; and
output the graphics to the external application.

12. The machine-readable medium of claim 11, further comprising computer-executable code to:
interpret the instructions, the graphics being generated based on the interpreted instructions.

13. The machine-readable medium of claim 12, wherein the instructions comprise XML code and interpreting comprises parsing the XML code.

14. The machine-readable medium of claim 11, wherein generating the graphics comprises:
obtaining geographic information from a geocoding service; and
integrating the geographic information into the graphics.

15. The machine-readable medium of claim 14, wherein the geographic information comprises a map and integrating comprises combining the map with other graphics.

16. The machine-readable medium of claim 11, wherein generating the graphics comprises:
retrieving the elements for the graphics; and
arranging the elements to create the graphics.

17. The machine-readable medium of claim 11, wherein the elements are retrieved from one or both of a database that is internal to the server and a database that is external to the server.

18. The machine-readable medium of claim 11, wherein the graphics comprise one or more of network graphics and charts.

19. The machine-readable medium of claim 11, wherein generating the graphics comprises converting the graphics from one format into a different format.

20. The machine-readable medium of claim 11, wherein generating the graphics comprises converting the graphics from one size into a different size.

21. An apparatus to generate graphics to output to an external application, comprising:
a memory that stores executable computer code; and
a processor that executes the computer code to:
receive instructions originating from the external application;
generate one of plural different types of graphics based on the instructions by combining elements from one or more graphics sources; and
output the graphics to the external application.

22. The apparatus of claim 21, wherein the processor executes computer code to:
interpret the instructions, the graphics being generated based on the interpreted instructions.

23. The apparatus of claim 22, wherein the instructions comprise XML code and interpreting comprises parsing the XML code.

24. The apparatus of claim 21, wherein generating the graphics comprises:
obtaining geographic information from a geocoding service; and
integrating the geographic information into the graphics.

25. The apparatus of claim 24, wherein the geographic information comprises a map and integrating comprises combining the map with other graphics.

26. The apparatus of claim 21, wherein generating the graphics comprises:
retrieving the elements for the graphics; and
arranging the elements to create the graphics.

27. The apparatus of claim 21, wherein the elements are retrieved from one or both of a database that is internal to the server and a database that is external to the apparatus.

28. The apparatus of claim 21, wherein the graphics comprise one or more of network graphics and charts.

29. The apparatus of claim 31, wherein generating the graphics comprises converting the graphics from one format into a different format.

30. The apparatus of claim 1, wherein generating the graphics comprises converting the graphics from one size into a different size.
